(19) United States
(12) Patent Application Publication
(10) Pub. No.: US 2016/0309335 A1
(43) Pub. Date: Oct. 20, 2016

(54) UNLICENSED CARRIER EVALUATING METHOD AND EVOLVED NODE B USING THE SAME

(71) Applicant: INDUSTRIAL TECHNOLOGY RESEARCH INSTITUTE, Hsinchu (TW)

(72) Inventors: Wei-Chen PAO, Zhubei City (TW); Hung-Hsiang WANG, Zhudong Township (TW)

(73) Assignee: INDUSTRIAL TECHNOLOGY RESEARCH INSTITUTE, Hsinchu (TW)

(21) Appl. No.: 15/086,161

(22) Filed: Mar. 31, 2016

Related U.S. Application Data
(60) Provisional application No. 62/147,617, filed on Apr. 15, 2015.

(51) Int. Cl. H04W 16/14; H04W 72/04

(52) U.S. Cl. CPC H04W 16/14; H04W 72/0453

(57) ABSTRACT

An unlicensed carrier evaluating method and an evolved Node B (eNB) using the same are provided. The unlicensed carrier evaluating method includes the following steps. An eNB transmits a configuration information to at least one user equipment (UE). The configuration information includes a timing parameter. The at least one UE transmits at least one preamble sequence to a Licensed Assisted Access (LAA) node through at least one unlicensed carrier according to the configuration information. The LAA node is connected to the eNB. The eNB or the LAA node evaluates a transmission efficiency of the at least one unlicensed carrier according to the at least one preamble sequence.

This application claims the benefit of U.S. provisional application Ser. No. 62/147,617, filed Apr. 15, 2015, the disclosure of which is incorporated by reference herein in its entirety.

### TECHNICAL FIELD

The disclosure relates in general to an unlicensed carrier evaluating method and an evolved node B using the same.

### BACKGROUND

Along with the development of wireless communication, Long Term Evolution (LTE) technology having higher communication speed is invented. In the LTE technology, the evolved Node B (eNB) controls licensed carriers. In one case, a licensed Assisted Access (LAA) node may provide service to a user equipment (UE) through unlicensed carriers.

However, because the LAA node and other radio access technologies (RAT) node may be interfered with each other, it is difficult to select good unlicensed carriers.

### SUMMARY

The disclosure is directed to an unlicensed carrier evaluating method and an evolved node B using the same.

According to one embodiment, an unlicensed carrier evaluating method is provided. The unlicensed carrier evaluating method includes the following steps. An evolved Node B (eNB) transmits a configuration information to at least one user equipment (UE). The configuration information includes a timing parameter. The at least one UE transmits at least one preamble sequence to a Licensed Assisted Access (LAA) node through at least one unlicensed carrier according to the configuration information. The LAA node is connected to the eNB. The eNB or the LAA node evaluates a transmission efficiency of the at least one unlicensed carrier according to the at least one preamble sequence.

According to another embodiment, an unlicensed carrier evaluating method is provided. The unlicensed carrier evaluating method includes the following steps. An evolved Node B (eNB) transmits a configuration information to at least one user equipment (UE). The configuration information includes a timing parameter. The at least one UE records a Received Signal Strength Indication (RSSI) information of at least one unlicensed carrier according to the configuration information. The eNB or a Licensed Assisted Access (LAA) node evaluates a transmission efficiency of the at least one unlicensed carrier according to the RSSI information. The LAA node is connected to the eNB.

According to an alternative embodiment, an evolved Node B (eNB) is provided. The eNB receives a Received Signal Strength Indication (RSSI) information of at least one unlicensed carrier or at least one preamble sequence. The RSSI information is transmitted by at least one user equipment (UE). The at least one preamble sequence is transmitted through the at least one unlicensed carrier. The eNB evaluates a transmission efficiency of the at least one unlicensed carrier according to the RSSI information or the at least one preamble sequence.

### BRIEF DESCRIPTION OF THE DRAWINGS

FIG. 1 shows an interference happened on one unlicensed carrier.

FIG. 2 shows a flowchart of an unlicensed carrier evaluating method according to an embodiment.

FIG. 3 shows the step S220 of transmitting a preamble sequence in FIG. 2.

FIG. 4 shows a flowchart of an unlicensed carrier evaluating method according to another embodiment.

FIG. 5 shows a way to stop performing the unlicensed carrier evaluating method.

FIG. 6 shows one timing parameter.

FIG. 7 shows a plurality of timing parameters of a plurality of unlicensed carriers.

FIG. 8 shows a way to calibrate an uplink timing.

FIG. 9 shows two embodiments of the step S430 in FIG. 4.

FIG. 10 illustrates one example of the unlicensed carrier evaluating method.

FIG. 11 illustrates another example of the unlicensed carrier evaluating method.

FIG. 12 illustrates another example of the unlicensed carrier evaluating method.

FIG. 13 illustrates another example of the unlicensed carrier evaluating method.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

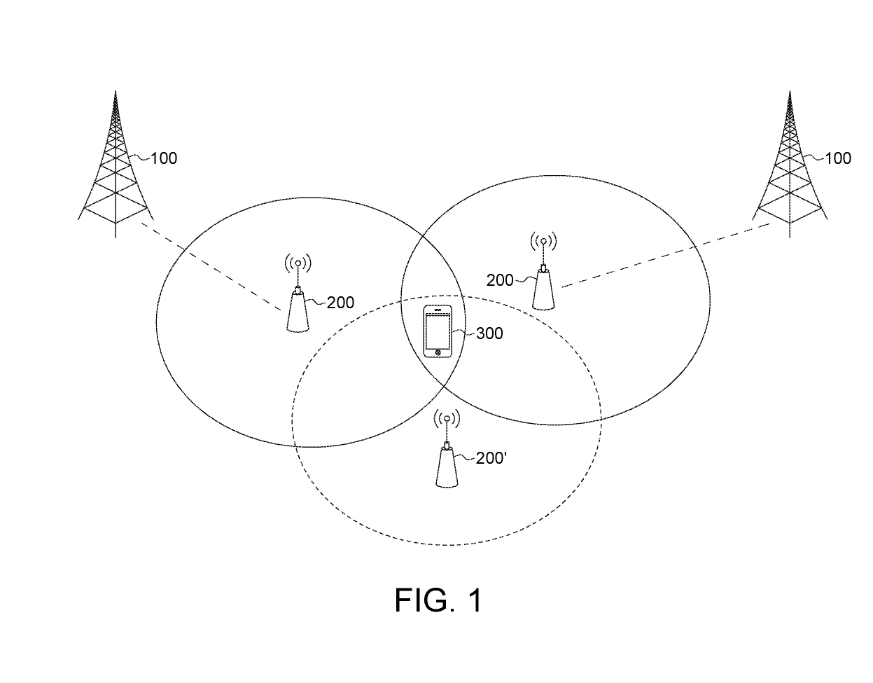

Please refer to FIG. 1, which shows an interference happened on one unlicensed carrier. Each of two Licensed Assisted Access (LAA) nodes 200 is connected to and controlled by one evolved Node B (eNB) 100. When a user equipment (UE) 300 is going to communicate with one LAA node 200 through one unlicensed carrier, it may be interfered with one radio access technologies (RAT) node 200′.

By performing the following embodiments, a transmission efficiency of one unlicensed carrier can be evaluated, or some of a plurality of unlicensed carriers which are suitable can be selected.

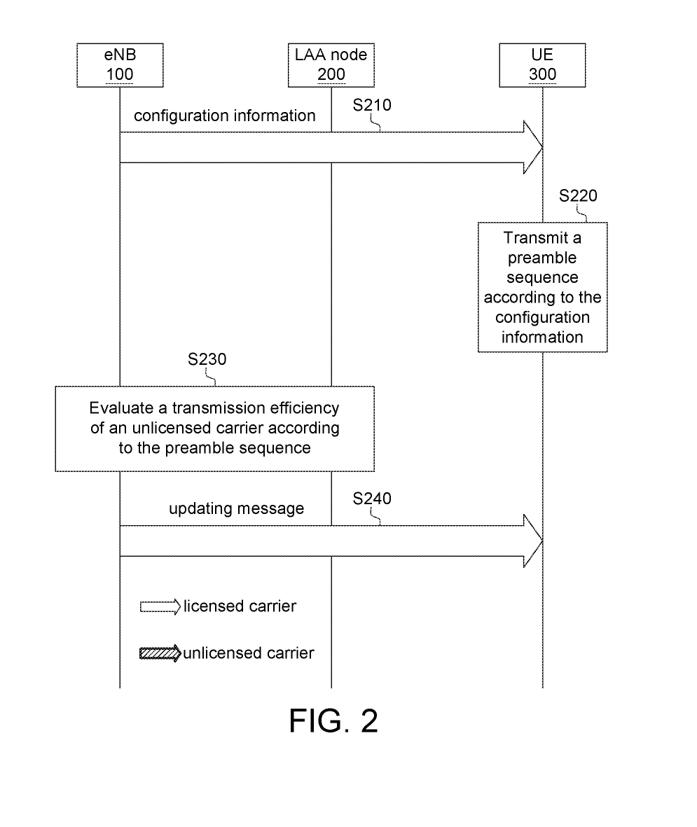

Please refer to FIG. 2, which shows a flowchart of an unlicensed carrier evaluating method according to an embodiment. In step S210, the eNB 100 transmits a configuration information to the UE 300. For example, the configuration information may include a timing parameter, a UE configuration parameter, a frequency configuration parameter and a transmitting power, but it is not limited thereto. In this step, the eNB 100 provides the configuration information to the UE 300 through a license carrier. In the timing parameter, some of time sections for performing the evaluating method are defined. In the UE configuration parameter, the identification of each UE 300 is defined. The UE configuration parameter can be a resource block configuration information or a spreading code configuration information. In the case of time division, the UE configuration parameter is the resource block configuration information. In the case of frequency division, the UE configuration parameter is the spreading code configuration information. In the frequency configuration parameter, the frequency corresponding each unlicensed carrier is defined. In this step, the configuration information can be transmitted via a Radio Resource Control (RRC) message.

Then, in step S220, the UE 300 transmits at least one preamble sequence to the LAA node 200 through at least one unlicensed carrier according to the configuration information. In this step, a Listen-Before-Talk (LBT) procedure or a Clear Channel Assessment (CCA) procedure is performed. The preamble sequence is a signal of a physical layer.

The preamble sequence can be a whole band signal or a partial band signal. Moreover, the preamble sequence is transmitted under a transmitting power. The eNB 100 can define a new transmitting power. For example, the transmitting power can be dynamically adjusted according to the number of the preamble sequences, the times of the successful transmission of the preamble sequence, or the probability of the successful transmission of the preamble sequence.

When one unlicensed carrier is interfered slightly, the UE 300 may transmit at least one preamble sequence, because the probability of the successful transmission of the preamble sequence to the LAA node 200 is high; when one unlicensed carrier is interfered seriously, the UE 300 may not transmit any preamble sequence, because the probability of the successful transmission of the preamble sequence to the LAA node 200 is low.

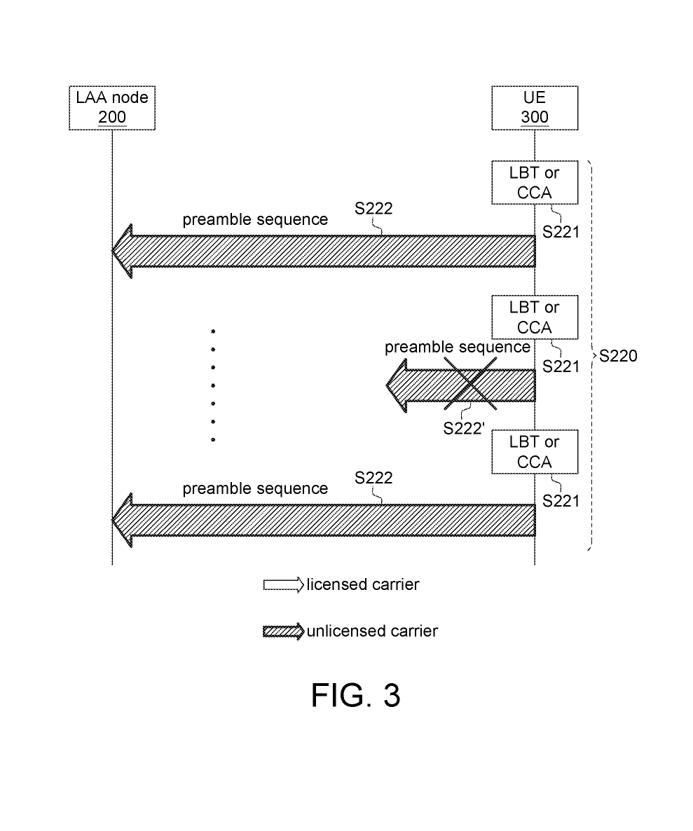

For example, please refer to FIG. 3, which show the step S220 of transmitting the preamble sequence in FIG. 2. In the step S220, the UE 300 performs the LBT procedure or the CCA procedure in step S221, and then the preamble sequence is transmitted in step S222. The UE 100 performs the step S221 and the step S222 for several times according to the timing information. However, the preamble sequence may not be successfully transmitted to the LAA node in each step S222. As shown in step S222′ of FIG. 3, the preamble sequence cannot be successfully transmitted.

In the step S230 of FIG. 2, the eNB 100 or the LAA node 200 evaluates a transmission efficiency of the at least one unlicensed carrier according to the preamble sequence. For example, the transmission efficiency of each unlicensed carrier can be evaluated according to a number of the at least one preamble sequence each of which is successfully received. Or, the transmission efficiency of each unlicensed carrier can be evaluated according to a signal strength or a signal quality of the at least one preamble sequence, such as signal to noise ratio (SINR) Reference Signal Receiving Power (RSRP) information or Reference Signal Receiving Quality (RSRQ) information.

Then, in step S240, the eNB 100 transmits an updating message to the UE 300. The updating message includes an available state of the at least one unlicensed carrier. For example, the available state indicates whether a particular unlicensed carrier is available, or some of a plurality of unlicensed carriers which are available.

In one embodiment, when the UE 300 connected to one eNB 100 is moved and connected to another eNB 100, the previous connected eNB 100 and the currently connected eNB 100 will exchange information via a

Handover message. The configuration information can be recorded in the Handover message, so the currently connected eNB 100 can obtain the configuration information via the Handover message.

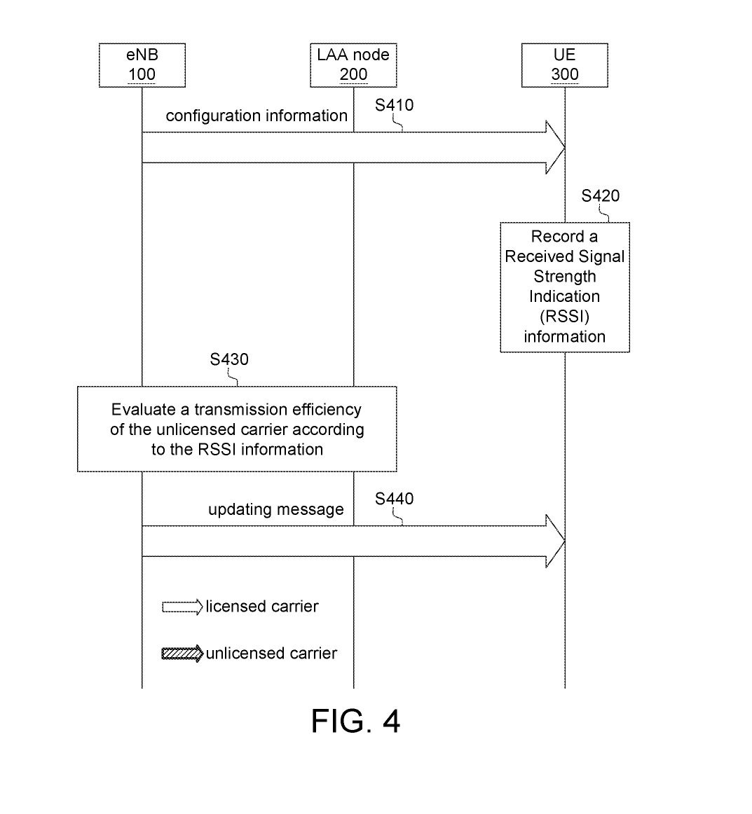

In FIG. 2, the transmission efficiency of the unlicensed carrier can be evaluated according to the preamble sequence. In another embodiment shown in FIG. 4, the unlicensed carrier can be evaluated without transmitting any preamble sequence. Please refer to FIG. 4, which shows a flowchart of an unlicensed carrier evaluating method according to another embodiment. In step S410, the eNB 100 provides the configuration information to the UE 300. The configuration information is similar as above, and the similarities will not be repeated.

In step S420, the UE 300 records a Received Signal Strength Indication (RSSI) information of at least one unlicensed carrier according to the configuration information.

When one unlicensed carrier is interfered slightly, the RSSI information of this unlicensed carrier is low; when one unlicensed carrier is interfered seriously, the RSSI information of this unlicensed carrier is high.

In step S430, the eNB 100 or the LAA node 200 evaluates the transmission efficiency of the unlicensed carrier according to the RSSI information. For example, the transmission efficiency of the unlicensed carrier can be evaluated according to the level of the RSSI information.

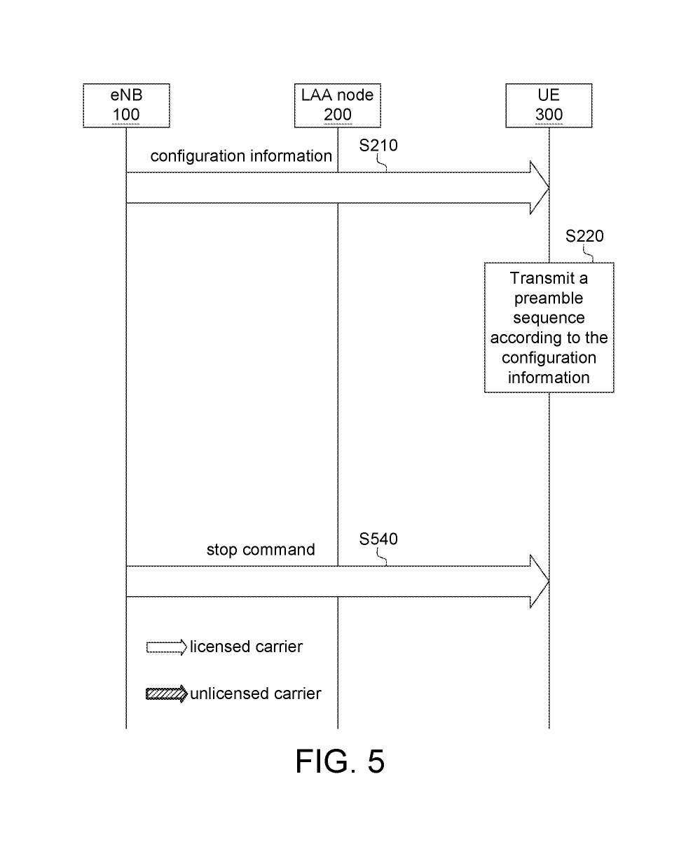

In the embodiment of FIG. 2, the preamble sequence is transmitted in the step S220, and the transmission efficiency of the unlicensed carrier is evaluated according to the preamble sequence in the step S230. In the embodiment of FIG. 4, instead of transmitting the preamble sequence, the RSSI information is recorded in the step S420 and the transmission efficiency of the unlicensed carrier is evaluated according to the RSSI information. Please refer to FIG. 5, which shows a way to stop performing the unlicensed carrier evaluating method. When the step S220 is being performed, in step S540, the eNB 100 can transmit a stop command to the UE 300 to inform the UE 300 to stop performing the step S220 of transmitting the preamble sequence. In this step, the stop command can be transmitted via a Radio Resource Control (RRC) message.

Similarly, the embodiment of FIG. 5 can be applied in the unlicensed carrier evaluating method of FIG. 4 to inform the UE 300 to stop performing the step S420 of recording the RSSI information.

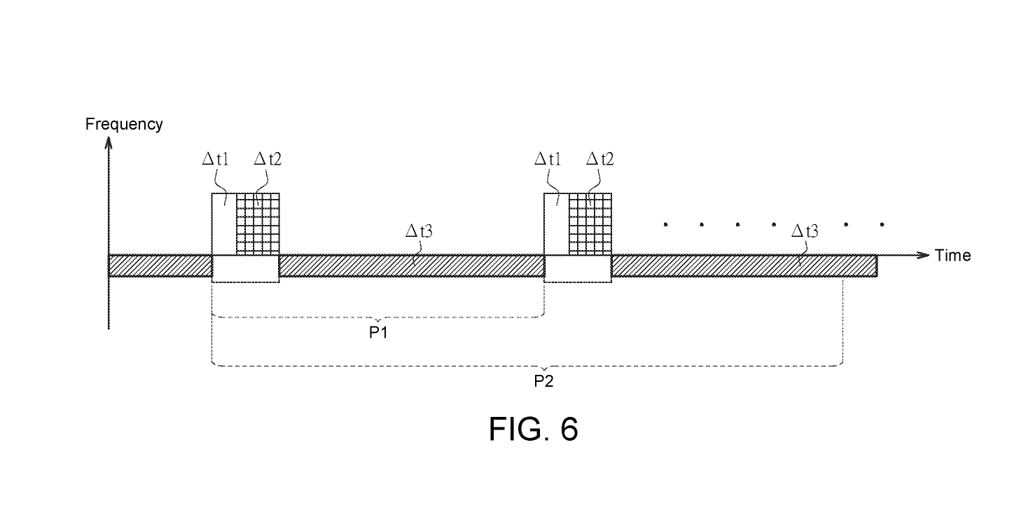

Please refer to FIG. 6, which shows one timing parameter. The timing parameter of the configuration information includes at least one evaluating period P2. Each evaluating period P2 includes a plurality of cycles P1. Each cycle P1 is used for performing the LBT procedure once. That is to say, in the evaluating period P2, the LBT procedure is performed several times.

The eNB 100 and the UE 300 can define the timing parameter according to the downlink time, the discovery reference signal (DRS) time, or the timing advance group indication.

Each cycle P1 includes a channel assessing section Δt1, a preamble transmitting section Δt2 and a data transmitting section Δt3 which are sequentially arranged. The channel assessing section Δt1 is used for performing a Clear Channel Assessment (CCA) procedure. The preamble transmitting section Δt2 is used for transmitting the preamble sequence. The data transmitting section Δt3 is used for transmitting data. The interval between two adjacent preamble transmitting sections Δt2 is the combination of the channel assessing section Δt1 and the data transmitting section Δt3. The channel assessing section Δt1 and the preamble transmitting section Δt2 occupy the idle time, without effecting the data transmission in the data transmitting section Δt3. In one embodiment, if no data is needed to be transmitted, the length of the data transmitting section Δt3 can be 0. That is to say, each cycle P1 only includes the channel assessing section Δt1 and the preamble transmitting section Δt2.

For example, in the unlicensed carrier evaluating method of FIG. 2, the LBT procedure is completely performed, and the preamble sequence is transmitted in the preamble transmitting section Δt2. In the unlicensed carrier evaluating method of FIG. 4, only the Clear Channel Assessment (CCA) procedure is performed, and the RSSI information is recorded in the channel assessing section Δt1.

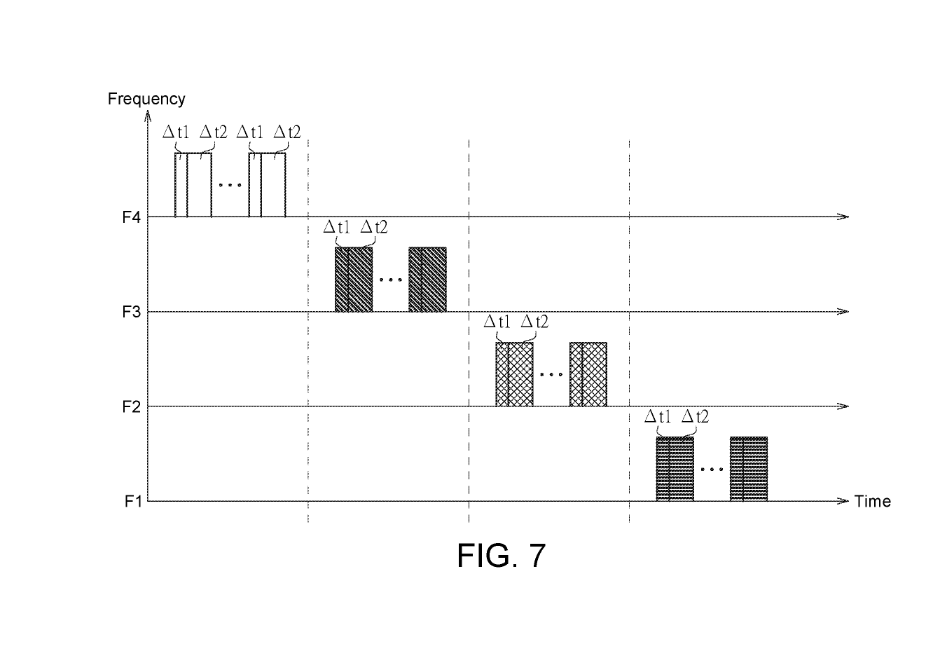

Please refer to FIG. 7, which shows a plurality of timing parameters of a plurality of unlicensed carriers. The unlicensed carriers respectively correspond frequency bands F1 to F4. In those frequency bands F1 to F4, the channel assessing sections Δt1 are not overlapped with each other and the preamble transmitting section Δt2 are not overlapped with each other. That is to say, at any time, only one of the frequency bands F1 to F4 is used to perform the step S220 of transmitting the preamble sequence (or the step S420 of recording the RSSI information).

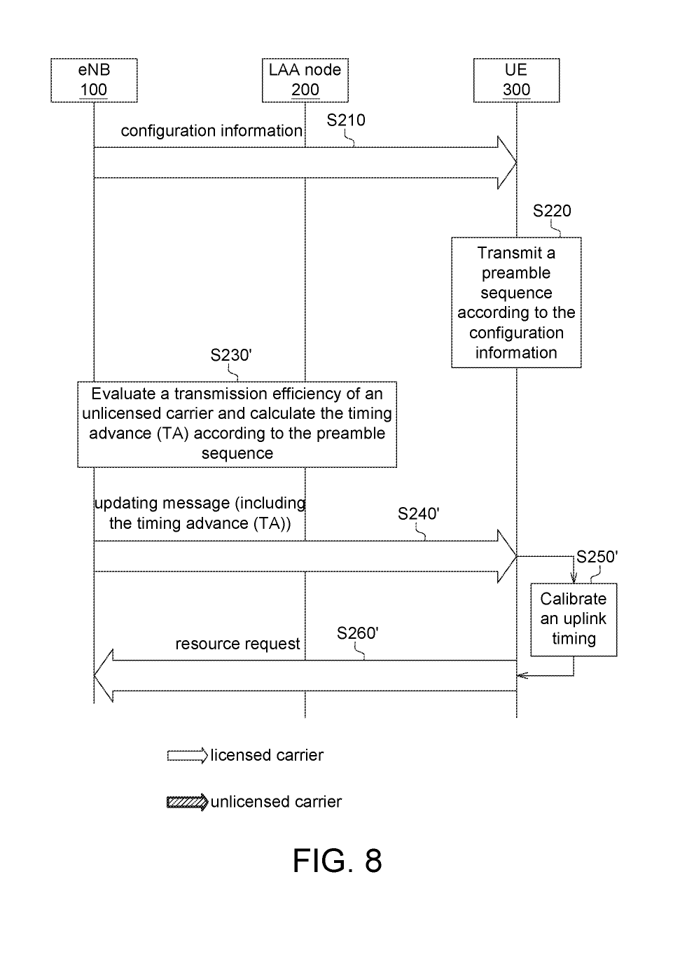

Please refer to FIG. 8, which shows a way to calibrate an uplink timing. In step S230′, the eNB 100 or the LAA node 200 not only evaluates the transmission efficiency of the art least one unlicensed carrier, but also calculates the timing advance (TA) according to the preamble sequence.

In step S240′, the updating message transmitted from the eNB 100 not only includes the available state of the at least one unlicensed carrier, but also includes the timing advance (TA).

In step 250′, the UE 300 calibrates the uplink timing according to the timing advance (TA). In step S260′, the UE 300 replies a resource request to the eNB 100.

That is to say, in the unlicensed carrier evaluating method according to the above embodiments, the timing advance (TA) can be obtained to calibrate the uplink timing.

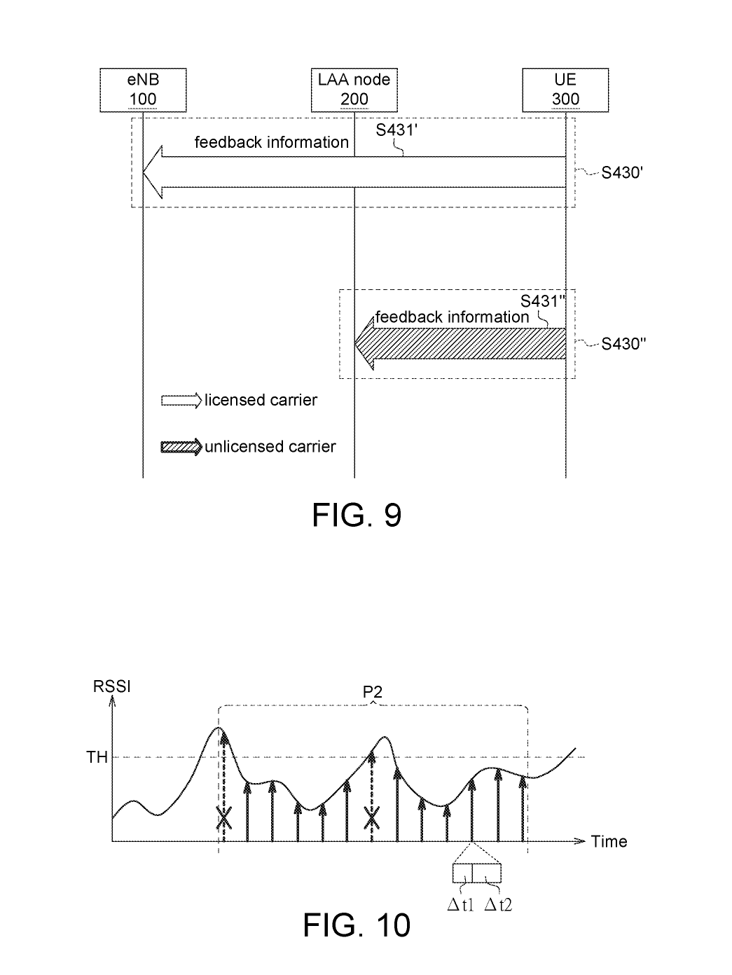

Please refer to FIG. 9, which shows two embodiments of the step S430 in FIG. 4. In step S430 of FIG. 4, the eNB 100 or the LAA node 200 evaluates the transmission efficiency of the unlicensed carrier according to the RSSI information. In the step S430′ of FIG. 9, the UE 300 may transmit a feedback information to the eNB 100 through the licensed carrier at step S431′. Moreover, in the step S430″ of FIG. 9, the UE 300 may transmit a feedback information to the eNB 100 through the unlicensed carrier at step S431″. The feedback information includes a statistical result of the RSSI information or the CCA procedure.

Please refer to FIG. 10, which illustrates one example of the unlicensed carrier evaluating method. In FIG. 10, there are 13 channel assessing sections Δt1 and 13 preamble transmitting sections Δt2 in the evaluating period P2, and the transmission of the preamble sequence is performed for 13 times. In FIG. 10, the intervals between any two adjacent preamble transmitting sections Δt2 are identical. In each transmission of the preamble sequence, one or several preamble sequences can be transmitted. If any preamble sequence is received by the LAA node 200, this transmission of the preamble sequence is deemed as a successful transmission. If no preamble sequence is received by the LAA node 200, this transmission of the preamble sequence is deemed as a failure transmission. As shown in FIG. 10, the first transmission and the seventh transmission are failure transmissions, and others are successful transmissions. The eNB 100 or the LAA node 200 can perform a calculation to obtain a statistical result. The statistical result of FIG. 10 is that the probability of the successful transmission of the preamble sequence is 11/13, which is larger than a predetermined probability level (80%), and the transmission efficiency of the unlicensed carrier is good.

Or, the times of the successful transmission can be used for evaluating. As shown in FIG. 10, the first transmission and the seventh transmission are failure transmissions, and others are successful transmissions. The statistical result of FIG. 10 is that the times of the successful transmission is 11, which is larger than a predetermined times level (10), and the transmission efficiency of the unlicensed carrier is good.

In another embodiment, there are 13 channel assessing sections Δt1 and 13 preamble transmitting sections Δt2 in the evaluating period P2 of FIG. 10, and the CCA procedure can be performed for 13 times. In each CCA procedure, whether the RSSI information is lower than a threshold TH is determined. If the RSSI information is lower than the threshold TH, then the CCA procedure is successfully passed; if the RSSI information is not lower than the threshold TH, then the CCA procedure is failed. As shown in FIG. 10, the first CCA procedure and the seventh CCA procedure are failed, and others are successfully passed. The UE 300 can perform a calculation to obtain a statistical result. The statistical result of FIG. 10 is that the probability of successful CCA procedure is 11/13, which is larger than the predetermined probability level (80%), and the transmission efficiency of the unlicensed carrier is good.

Or, the times of the successful CCA procedure can be used for evaluating. As shown in FIG. 10, the first CCA procedure and the seventh CCA procedure are failed, and others are successful CCA procedures. The statistical result of FIG. 10 is that the times of the successful CCA procedures is 11, which is larger than the predetermined times level (10), and the transmission efficiency of the unlicensed carrier is good.

Or, in another embodiment, the RSSI information in each CCA procedure can be transmitted to the eNB 100 or the LAA node 200, and the eNB 100 or the LAA node 200 calculates the statistical result according to the threshold TH.

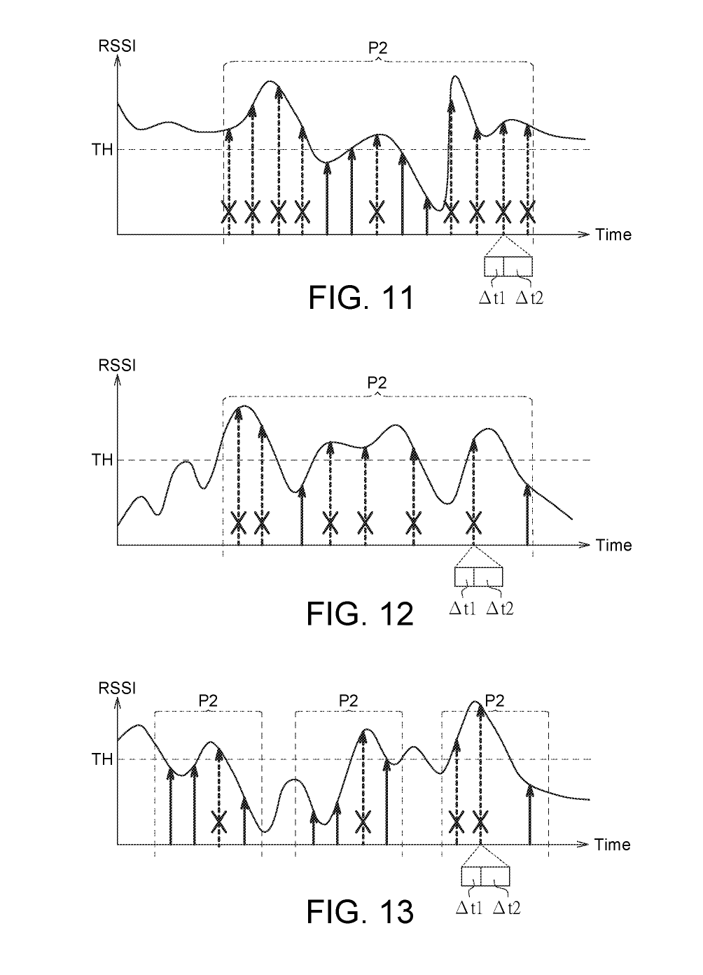

Please refer to FIG. 11, which illustrates another example of the unlicensed carrier evaluating method. In FIG. 11, only the fifth transmission, the sixth transmission, the eighth transmission and the ninth transmission are successful transmissions. The eNB 100 or the LAA node 200 can perform a calculation to obtain a statistical result. The statistical result of FIG. 11 is that the probability of the successful transmission of the preamble sequence is 4/13, which is lower than the predetermined probability level (80%), and the times of the successful transmission is 4, which is lower than the predetermined times level (10). The transmission efficiency of the unlicensed carrier is bad.

Or, the CCA procedure can be used for evaluating, without transmitting any preamble sequence. Similarities are described as above and are not repeated here.

Please refer to FIG. 12, which illustrates another example of the unlicensed carrier evaluating method. In the evaluating period P2, a plurality of intervals among the preamble transmitting sections Δt2 are randomly changed according to a random backoff algorithm. For example, if two consecutive transmissions of the preamble sequences are failure transmissions, then the length of the channel assessing section Δt1 is increased to postpone the next transmission of the preamble sequence. Therefore, the failure transmissions of the preamble sequences will not be frequently repeated in a short time.

Similarly, the CCA procedure can be used for evaluating in the example of FIG. 12, without transmitting any preamble sequence. Similarities are described as above and are not repeated here.

Please refer to FIG. 13, which illustrates another example of the unlicensed carrier evaluating method. In FIG. 13, the number of the evaluating periods P2 is plurality. In the step of calculating the statistical result, the times of the successful transmissions can be divided by the times of all of the transmissions to obtain the probability of the successful transmission, i.e. 7/12. Or, the probability of the successful transmission in each evaluating period P2 can be calculated and then the probabilities in all of the evaluating periods P2 can be averaged to obtain the probability of the successful transmission, i.e. (3/4+3/4+1/4)/3.

Similarly, the CCA procedure can be used for evaluating in the example of FIG. 13, without transmitting any preamble sequence. Similarities are described as above and are not repeated here.

According to another embodiment, an eNB is provided. The eNB receives a RSSI information of at least one unlicensed carrier or at least one preamble sequence. The RSSI information is transmitted by at least one UE. The at least one preamble sequence is transmitted through the at least one unlicensed carrier. The eNB evaluates a transmission efficiency of the at least one unlicensed carrier according to the RSSI information or the at least one preamble sequence.

According to the above embodiments, the transmission efficiency of the unlicensed carrier can be evaluated by transmitting the preamble sequence or recording the RSSI information. Or, some of a plurality of unlicensed carriers which are suitable can be selected. Therefore, the interference happened on the unlicensed carriers can be avoided.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An unlicensed carrier evaluating method, comprising:
transmitting, by an evolved Node B (eNB), a configuration information to at least one user equipment (UE), the configuration information including a timing parameter;
transmitting, by the at least one UE, at least one preamble sequence to a Licensed Assisted Access (LAA) node through at least one unlicensed carrier according to the configuration information, wherein the LAA node is connected to the eNB; and
evaluating, by the eNB or the LAA node, a transmission efficiency of the at least one unlicensed carrier according to the at least one preamble sequence.

2. The unlicensed carrier evaluating method according to claim 1, wherein in the step of transmitting the at least one preamble sequence, a Listen-Before-Talk (LBT) procedure or a Clear Channel Assessment (CCA) procedure is performed.

3. The unlicensed carrier evaluating method according to claim 1, wherein the eNB provides the configuration information to the at least one UE through a licensed carrier.

4. The unlicensed carrier evaluating method according to claim 1, wherein the timing parameter includes at least one evaluating period, the at least one evaluating period includes a plurality of cycles, each of the cycles includes a channel assessing section, a preamble transmitting section and a data transmitting section which are sequentially arranged, the channel assessing section is used for performing a Clear Channel Assessment (CCA) procedure, the preamble transmitting section is used for transmitting the at least one preamble sequence, and the data transmitting section is used for transmitting data.

5. The unlicensed carrier evaluating method according to claim 4, wherein a number of the at least one evaluating period is plurality.

6. The unlicensed carrier evaluating method according to claim 4, wherein in each of the at least one evaluating period, a plurality of intervals among the preamble transmitting sections of the cycles are identical.

7. The unlicensed carrier evaluating method according to claim 4, wherein in each of the at least one evaluating period, a plurality of intervals among the preamble transmitting sections of the cycles are randomly changed according to a random backoff algorithm.

8. The unlicensed carrier evaluating method according to claim 1, wherein a number of the at least one UE is plurality, the configuration information further includes a UE configuration parameter, the UE configuration parameter is a resource block configuration information or a spreading code configuration information.

9. The unlicensed carrier evaluating method according to claim 1, wherein a number of the at least one unlicensed carrier is plurality, and the configuration information further includes a frequency configuration parameter.

10. The unlicensed carrier evaluating method according to claim 1, wherein in the step of evaluating the transmission efficiency of the at least one unlicensed carrier, the eNB or the LAA node evaluates the transmission efficiency of the at least one unlicensed carrier according to a number of the at least one preamble sequence each of which is received by the LAA node.

11. The unlicensed carrier evaluating method according to claim 1, wherein in the step of evaluating the transmission efficiency of the at least one unlicensed carrier, the eNB or the LAA node evaluates the transmission efficiency of the at least one unlicensed carrier according to a signal strength or a signal quality of the at least one preamble sequence.

12. The unlicensed carrier evaluating method for the unlicensed carrier according to claim 1, wherein the at least one preamble sequence is transmitted under a transmitting power, and the transmitting power is set by the eNB.

13. The unlicensed carrier evaluating method according to claim 1, further comprising:
transmitting, by the eNB, an updating message to the at least one UE for informing an available state of the at least one unlicensed carrier.

14. The unlicensed carrier evaluating method according to claim 13, wherein the updating message includes a timing advance (TA).

15. The unlicensed carrier evaluating method according to claim 1, wherein the eNB obtains the configuration information from a Handover message transmitted by another eNB.

16. The unlicensed carrier evaluating method according to claim 1, further comprising:
transmitting, by the eNB, a stop command to the at least one UE to stop performing the step of transmitting the at least one preamble sequence.

17. An unlicensed carrier evaluating method, comprising:
transmitting, by an evolved Node B (eNB), a configuration information to at least one user equipment (UE), the configuration information including a timing parameter;
recording, by the at least one UE, a Received Signal Strength Indication (RSSI) information of at least one unlicensed carrier according to the configuration information; and
evaluating, by the eNB or a Licensed Assisted Access (LAA) node, a transmission efficiency of the at least one unlicensed carrier according to the RSSI information, wherein the LAA node is connected to the eNB.

18. The unlicensed carrier evaluating method according to claim 17, wherein the eNB or the LAA node evaluates the transmission efficiency of the at least one unlicensed carrier according to a statistical result of the RSSI information, and the statistical result is calculated by the at least one UE.

19. The unlicensed carrier evaluating method according to claim 17, wherein the eNB or the LAA node evaluates the transmission efficiency of the at least one unlicensed carrier according to a statistical result of the RSSI information, and the statistical result is calculated by the eNB or the LAA node.

20. The unlicensed carrier evaluating method according to claim 17, wherein the eNB provides the configuration information to the at least one UE through a licensed carrier.

21. The unlicensed carrier evaluating method according to claim 17, wherein a number of the at least one unlicensed carrier is plurality, and the configuration information further includes a frequency configuration parameter.

22. The unlicensed carrier evaluating method according to claim 17, wherein the timing parameter includes at least one evaluating period, the at least one evaluating period includes a plurality of cycles, each of the cycles includes a channel assessing section and a data transmitting section which are sequentially arranged, the channel assessing section is used for performing a Clear Channel Assessment (CCA) procedure and the data transmitting section is used for transmitting data.

23. An evolved Node B (eNB), wherein
the eNB receives a Received Signal Strength Indication (RSSI) information of at least one unlicensed carrier or at least one preamble sequence, the RSSI information is transmitted by at least one user equipment (UE), and the at least one preamble sequence is transmitted through the at least one unlicensed carrier; and
the eNB evaluates a transmission efficiency of the at least one unlicensed carrier according to the RSSI information or the at least one preamble sequence.
